(19) United States
(12) Patent Application Publication
(10) Pub. No.: US 2024/0156322 A1
(43) Pub. Date: May 16, 2024

(54) DISHWASHING APPLIANCE AND FILTER HAVING A VISUAL FILL VOLUME INDICATION

(71) Applicant: Haier US Appliance Solutions, Inc., Wilmington, DE (US)

(72) Inventors: Craig Curtis, Crestwood, KY (US); Kyle Edward Durham, Louisville, KY (US)

(21) Appl. No.: 17/986,405

(22) Filed: Nov. 14, 2022

(51) Int. Cl. A47L 15/42; B01D 29/03; B01D 29/35; B01D 29/56; B01D 35/30

(52) U.S. Cl. CPC A47L 15/4206; A47L 15/4204; A47L 15/4225; A47L 15/4244; B01D 29/03; B01D 29/35; B01D 29/56; B01D 35/30; A47L 2401/09; A47L 2401/14; B01D 2201/302

(57) ABSTRACT

A dishwashing appliance may include a cabinet, a tub, a sump, and a filter assembly. The tub may be positioned within the cabinet and define a wash chamber for receipt of articles for washing. The sump may be positioned at a bottom portion of the tub along a vertical direction. The sump may include an internal wall defining a collection chamber. The filter assembly may be at least partially received within the collection chamber. The filter assembly may include a top cap extending above the collection chamber. The top cap may include a fixed indicium calibrated to a predetermined fill volume of the dishwashing appliance.

### FIELD OF THE INVENTION

The present subject matter relates generally to dishwashing appliances, and more particularly to filter assemblies for the same.

### BACKGROUND OF THE INVENTION

Dishwashing appliances generally include a tub that defines a wash chamber. Rack assemblies can be mounted within the wash chamber of the tub for receipt of articles for washing. Multiple spray assemblies can be positioned within the wash chamber for applying or directing wash fluid (e.g., water, detergent, etc.) towards articles disposed within the rack assemblies in order to clean such articles. Dishwashing appliances are also typically equipped with one or more pumps, such as a circulation pump or a drain pump, for directing or motivating wash fluid from the wash chamber (e.g., to the spray assemblies or an area outside of the dishwashing appliance).

Conventional dishwashing appliances include one or more filter assemblies for filtering the wash fluid exiting the wash chamber. Depending upon the level of soil upon the articles, fluids used during wash and rinse cycles will become contaminated with sediment (e.g., soil, food particles, etc.) in the form of debris or particles that are carried with the fluid. In order to protect the pump and recirculate the fluid through the wash chamber, it is beneficial to filter the fluid so that relatively clean fluid is applied to the articles in the wash chamber and materials are removed or reduced from the fluid supplied to the pump. As a result, a filter assembly may be provided within or below a sump portion of the tub.

Even in the case of a well-maintained dishwashing appliance, issues can arise to affect the performance or cleaning ability of the appliance. For instance, the filter assembly may clog, a pump assembly may fail to perform correctly (e.g., to underfill or overfill the appliance with water), etc. In order to diagnose certain issues, it may be useful to generally know the volume of water within the dishwashing appliance (e.g., at the sump). Nonetheless, conventional appliances lack any method or features to help a reliably make such an identification. Although some appliances have pressure sensors for detecting the amount of water, the readings of such sensors are not typically available to users and may require a specialized technician or tool to be onsite to access readings from the pressure sensor.

As a result, it may be useful to provide to provide a dishwashing appliance having one or more features for reliably and easily determine a volume of water within the dishwashing appliance (e.g., visually).

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a dishwashing appliance is provided. The dishwashing appliance may include a cabinet, a tub, a sump, and a filter assembly. The tub may be positioned within the cabinet and define a wash chamber for receipt of articles for washing. The sump may be positioned at a bottom portion of the tub along a vertical direction. The sump may include an internal wall defining a collection chamber. The filter assembly may be at least partially received within the collection chamber. The filter assembly may include a top cap extending above the collection chamber. The top cap may include a fixed indicium calibrated to a predetermined fill volume of the dishwashing appliance.

In another exemplary aspect of the present disclosure, a dishwashing appliance is provided. The dishwashing appliance may include a cabinet, a tub, a sump, a filter assembly, and a coarse filter. The tub may be positioned within the cabinet and define a wash chamber for receipt of articles for washing. The sump may be positioned at a bottom portion of the tub along a vertical direction. The sump may include an internal wall defining a collection chamber. The filter assembly may be at least partially received within the collection chamber. The filter assembly may include a top cap extending above the collection chamber. The top cap may include a plurality of indicia calibrated to discrete predetermined fill volumes. The coarse filter may be disposed about the filter assembly below the top cap.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an exemplary embodiment of a dishwashing appliance of the present disclosure with a door in a partially open position.

FIG. 2 provides a side, cross sectional view of the exemplary dishwashing appliance of FIG. 1.

FIG. 3 provides a close up, cross sectional view of a sump and a fine filter assembly of the dishwashing appliance of FIGS. 1 and 2.

FIG. 4 provides a perspective view of the sump and fine filter assembly of the dishwashing appliance of FIGS. 1 through 3.

FIG. 5 provides a perspective view of a filter frame of the fine filter assembly of the dishwashing appliance of FIGS. 1 through 4.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, references to “an embodiment” or “one embodiment” does not necessarily refer to the same embodiment, although it may.

Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “upstream” and “downstream” refer to the relative flow direction with respect to fluid flow in a fluid pathway. For example, “upstream” refers to the flow direction from which the fluid flows, and “downstream” refers to the flow direction to which the fluid flows.

Generally, the present disclosure may provide dishwashing appliances and methods to detect and address a siphon condition that can arise, for instance, at a drain pump. For instance, certain predetermined changes in sump pressure (e.g., after a drain pump has been deactivated) may indicate a siphon condition. If such changes are detected, the drain pump may need to, for instance, temporarily reactivating the drain pump to stop the siphon condition.

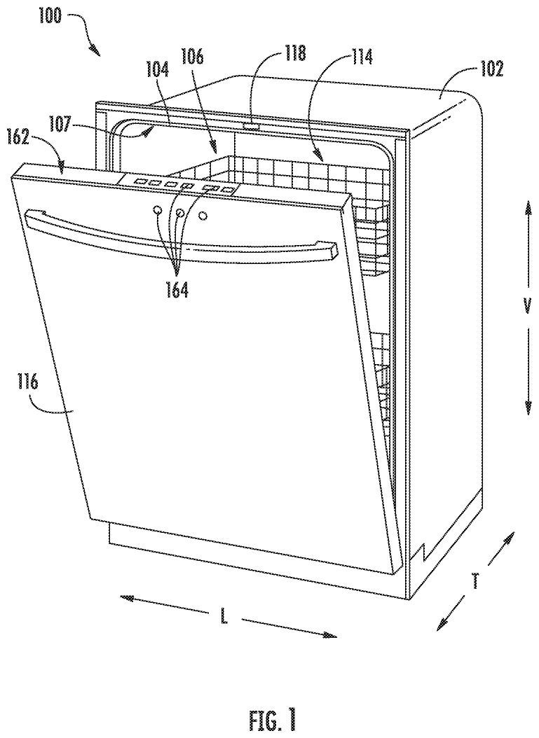

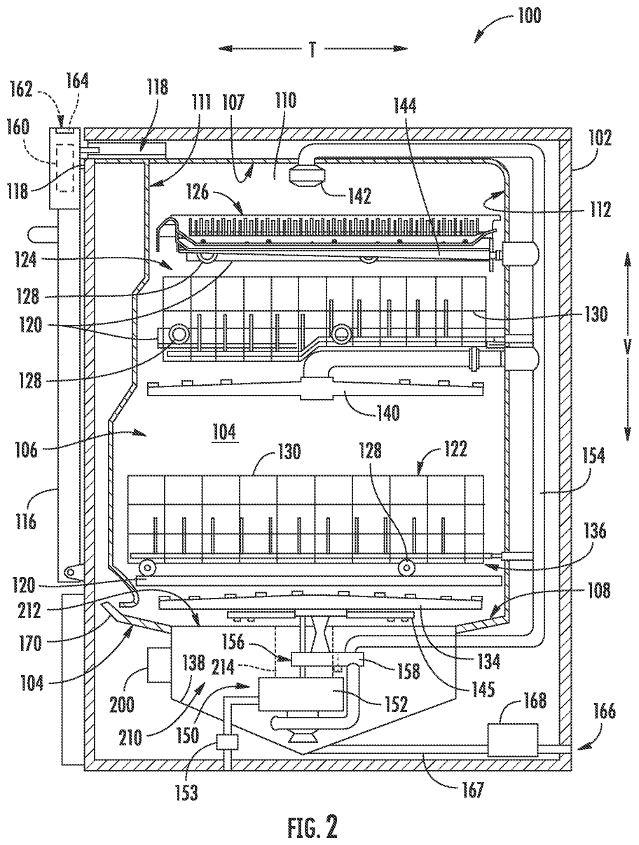

Turning now to the figures, FIGS. 1 and 2 depict an exemplary dishwasher or dishwashing appliance (e.g., dishwashing appliance 100) that may be configured in accordance with aspects of the present disclosure. Generally, dishwasher 100 defines a vertical direction V, a lateral direction L, and a transverse direction T. Each of the vertical direction V, lateral direction L, and transverse direction T are mutually perpendicular to one another and form an orthogonal direction system.

Dishwasher 100 includes a cabinet 102 having a tub 104 therein that defines a wash chamber 106. As shown in FIG. 2, tub 104 extends between a top 107 and a bottom 108 along the vertical direction V, between a pair of side walls 110 along the lateral direction L, and between a front side 111 and a rear side 112 along the transverse direction T.

Tub 104 includes a front opening 114. In some embodiments, a door 116 hinged at its bottom for movement between a normally closed vertical position, wherein the wash chamber 106 is sealed shut for washing operation, and a horizontal open position for loading and unloading of articles from dishwasher 100. A door closure mechanism or assembly 118 may be provided to lock and unlock door 116 for accessing and sealing wash chamber 106.

In exemplary embodiments, tub side walls 110 accommodate a plurality of rack assemblies. For instance, guide rails 120 may be mounted to side walls 110 for supporting a lower rack assembly 122, a middle rack assembly 124, or an upper rack assembly 126. In some such embodiments, upper rack assembly 126 is positioned at a top portion of wash chamber 106 above middle rack assembly 124, which is positioned above lower rack assembly 122 along the vertical direction V.

Generally, each rack assembly 122, 124, 126 may be adapted for movement between an extended loading position (not shown) in which the rack is substantially positioned outside the wash chamber 106, and a retracted position (shown in FIGS. 1 and 2) in which the rack is located inside the wash chamber 106. In some embodiments, movement is facilitated, for instance, by rollers 128 mounted onto rack assemblies 122, 124, 126, respectively.

Although guide rails 120 and rollers 128 are illustrated herein as facilitating movement of the respective rack assemblies 122, 124, 126, it should be appreciated that any suitable sliding mechanism or member may be used according to alternative embodiments.

In optional embodiments, some or all of the rack assemblies 122, 124, 126 are fabricated into lattice structures including a plurality of wires or elongated members 130 (for clarity of illustration, not all elongated members making up rack assemblies 122, 124, 126 are shown in FIG. 2). In this regard, rack assemblies 122, 124, 126 are generally configured for supporting articles within wash chamber 106 while allowing a flow of wash fluid to reach and impinge on those articles (e.g., during a cleaning or rinsing cycle). According to additional or alternative embodiments, a silverware basket (not shown) is removably attached to a rack assembly (e.g., lower rack assembly 122), for placement of silverware, utensils, and the like, that are otherwise too small to be accommodated by the rack assembly.

Generally, dishwasher 100 includes one or more spray assemblies for urging a flow of fluid (e.g., wash fluid) onto the articles placed within wash chamber 106.

In exemplary embodiments, dishwasher 100 includes a lower spray arm assembly 134 disposed in a lower region 136 of wash chamber 106 and above a sump 138 so as to rotate in relatively close proximity to lower rack assembly 122.

In additional or alternative embodiments, a mid-level spray arm assembly 140 is located in an upper region of wash chamber 106 (e.g., below and in close proximity to middle rack assembly 124). In this regard, mid-level spray arm assembly 140 may generally be configured for urging a flow of wash fluid up through middle rack assembly 124 and upper rack assembly 126.

In further additional or alternative embodiments, an upper spray assembly 142 is located above upper rack assembly 126 along the vertical direction V. In this manner, upper spray assembly 142 may be generally configured for urging or cascading a flow of wash fluid downward over rack assemblies 122, 124, and 126.

In yet further additional or alternative embodiments, upper rack assembly 126 may further define an integral spray manifold 144. As illustrated, integral spray manifold 144 may be directed upward, and thus generally configured for urging a flow of wash fluid substantially upward along the vertical direction V through upper rack assembly 126.

In still further additional or alternative embodiments, a filter clean spray assembly 145 is disposed in a lower region 136 of wash chamber 106 (e.g., below lower spray arm assembly 134) and above a sump 138 so as to rotate in relatively close proximity to a filter assembly 210. For instance, filter clean spray assembly 145 may be directed downward to urge a flow of wash fluid across a portion of filter assembly 210 (e.g., first filter 212) or sump 138.

The various spray assemblies and manifolds described herein may be part of a fluid distribution system or fluid circulation assembly 150 for circulating wash fluid in tub 104. In certain embodiments, fluid circulation assembly 150 includes a circulation pump 152 for circulating wash fluid in tub 104. Circulation pump 152 may be located within sump 138 or within a machinery compartment located below sump 138 of tub 104.

When assembled, circulation pump 152 may be in fluid communication with an external water supply line (not shown) and sump 138. A water inlet valve 153 can be positioned between the external water supply line and circulation pump 152 (e.g., to selectively allow water to flow from the external water supply line to circulation pump 152). Additionally or alternatively, water inlet valve 153 can be positioned between the external water supply line and sump 138 (e.g., to selectively allow water to flow from the external water supply line to sump 138). During use, water inlet valve 153 may be selectively controlled to open to allow the flow of water into dishwasher 100 and may be selectively controlled to cease the flow of water into dishwasher 100. Further, fluid circulation assembly 150 may include one or more fluid conduits or circulation piping for directing wash fluid from circulation pump 152 to the various spray assemblies and manifolds. In exemplary embodiments, such as that shown in FIG. 2, a primary supply conduit 154 extends from circulation pump 152, along rear 112 of tub 104 along the vertical direction V to supply wash fluid throughout wash chamber 106.

In some embodiments, primary supply conduit 154 is used to supply wash fluid to one or more spray assemblies (e.g., to mid-level spray arm assembly 140 or upper spray assembly 142). It should be appreciated, however, that according to alternative embodiments, any other suitable plumbing configuration may be used to supply wash fluid throughout the various spray manifolds and assemblies described herein. For instance, according to another exemplary embodiment, primary supply conduit 154 could be used to provide wash fluid to mid-level spray arm assembly 140 and a dedicated secondary supply conduit (not shown) could be utilized to provide wash fluid to upper spray assembly 142. Other plumbing configurations may be used for providing wash fluid to the various spray devices and manifolds at any location within dishwashing appliance 100.

Each spray arm assembly 134, 140, 142, integral spray manifold 144, filter clean assembly 145, or other spray device may include an arrangement of discharge ports or orifices for directing wash fluid received from circulation pump 152 onto dishes or other articles located in wash chamber 106. The arrangement of the discharge ports, also referred to as jets, apertures, or orifices, may provide a rotational force by virtue of wash fluid flowing through the discharge ports. Alternatively, spray assemblies 134, 140, 142, 145 may be motor-driven, or may operate using any other suitable drive mechanism. Spray manifolds and assemblies may also be stationary. The resultant movement of the spray assemblies 134, 140, 142, 145 and the spray from fixed manifolds provides coverage of dishes and other dishwasher contents with a washing spray. Other configurations of spray assemblies may be used as well. For instance, dishwasher 100 may have additional spray assemblies for cleaning silverware, for scouring casserole dishes, for spraying pots and pans, for cleaning bottles, etc.

In some embodiments, an exemplary filter assembly 210 is provided. As shown, in exemplary embodiments, filter assembly 210 is located in the sump 138 (e.g., to filter fluid to circulation assembly 150). Generally, filter assembly 210 removes soiled particles from the fluid that is recirculated through the wash chamber 106 during operation of dishwashing appliance 100. In exemplary embodiments, filter assembly 210 includes one or both of a first filter 212 (also referred to as a “coarse filter”) and a second filter 214 (also referred to as a “fine filter”).

In some embodiments, the first filter 212 is constructed as a grate having openings for filtering fluid received from wash chamber 106. The sump 138 includes a recessed portion upstream of circulation pump 152 or a drain pump 168 and over which the first filter 212 is removably received. In exemplary embodiments, the first filter 212 operates as a coarse filter having media openings in the range of about 0.030 inches to about 0.060 inches. The recessed portion may define a filtered volume wherein debris or particles have been filtered by the first filter 212 or the second filter 214.

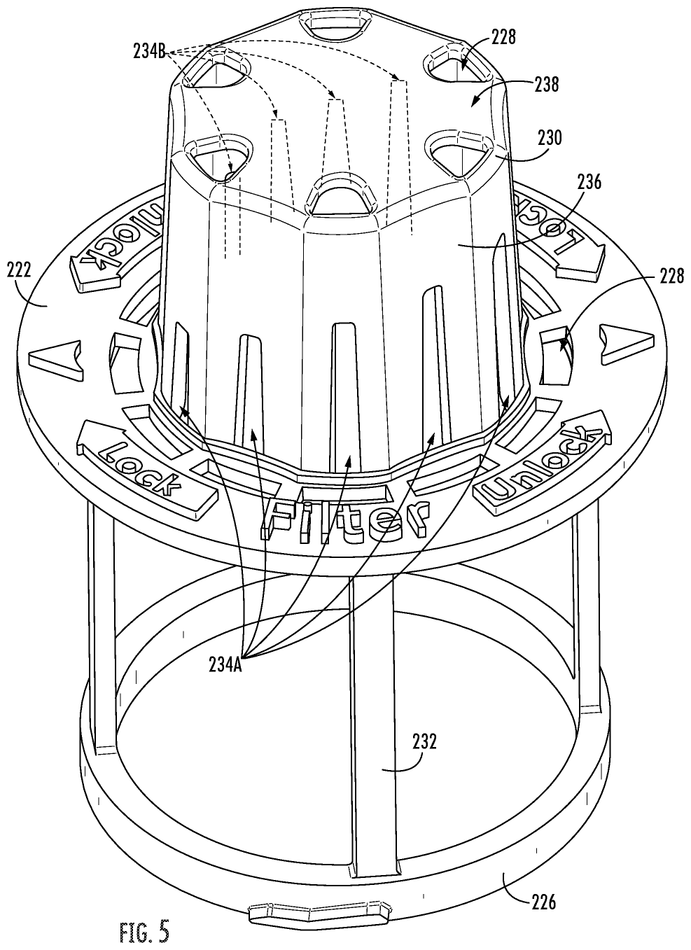

Turning especially to FIGS. 2 through 5, in additional or alternative embodiments, the second filter 214 is provided upstream of circulation pump 152 or drain pump 168. Generally, second filter 214 includes or is provided as an assembly with a filter cartridge having a cartridge frame 222 that is either removably or fixed mounted in sump 138.

For instance, the second filter 214 may be removably positioned (e.g., at least partially received) within a collection chamber 218 defined by tub receptacle 216. As shown, the tub receptacle 216 of the sump 138 includes an internal wall 217 defining collection chamber 218 into which wash fluid may collect. Internal wall 217 may, for instance, define a generally cylindrical or frusto-conical collection chamber 218 above a drain outlet in fluid communication with fluid circulation assembly. Internal wall 217 may generally extend about a sump axis defined thereby.

Cartridge frame 222 may include a base 226 and a top cap 230 joined together by one or more vertical frame members 232. When assembled, at least a portion of the second filter 214 may be generally shaped to complement the tub receptacle 216. For instance, the second filter 214 may include a filter wall 220 that complements the shape of the tub receptacle 216. In some embodiments, the filter wall 220 is formed from one or more fine filter media (e.g., supported by the vertical frame members 232). Some such embodiments may include filter media (e.g., screen or mesh, having pore or hole sizes in the range of about 50 microns to about 600 microns).

When assembled, the filter wall 220 may have an enclosed (e.g., cylindrical) shape defining an internal chamber 224. Optionally, first filter 212 may be disposed above the cylindrical filter wall 220 or about the cartridge frame 222 of second filter 214 generally. Above the filter wall 220 and internal chamber 224, top cap 230 may be held (e.g., above first filter 212). As shown, top cap 230 of second filter 214 may be positioned above internal chamber 224 may define one or more openings 228 permitting fluid to flow into internal chamber 224 without passing through the first filter 212 or the fine filter media of filter wall 220, or media of second filter 214 generally. In some embodiments, such openings 228 include a plurality of vertical holes extending through an upper surface 238 of the top cap 230 (e.g., above any fixed indicia 234, as described below). Top cap 230 may include or be formed as a handle that allows a user to grasp and remove the second filter 214 for replacement or cleaning. An opening defined through the first filter 212 allows for positioning of the second filter 214 into receptacle 216. Between openings 228 and drain pump 168, internal chamber 224 defines an unfiltered volume.

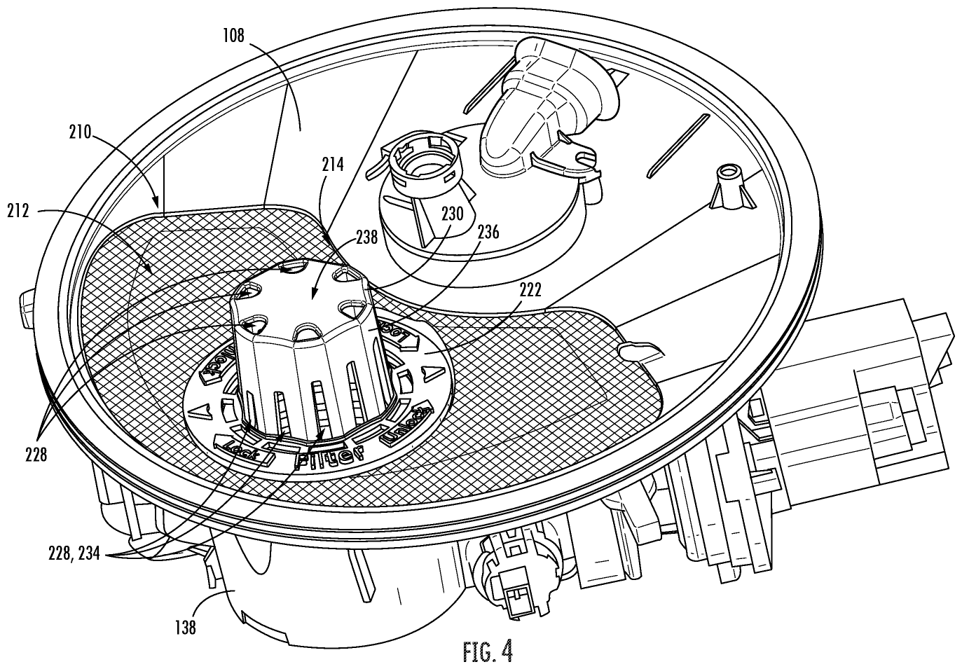

Turning especially to FIG. 4, top cap 230 includes one or more fixed indicia 234 that each extend, and are held, above collection chamber 218 (e.g., above the first filter 212). Generally, each fixed indicium 234 provides an inset, embossing, or slot that is formed on a radial wall 236 portion of the top cap 230 and is visually distinguishable from the surrounding portions thereof. Optionally, each fixed indicia 234 may include or is define a radial slot extending through the top cap 230 to permit a flow of water to the collection chamber 218 (e.g., as one of the openings 228).

Each fixed indicium 234 is calibrated to a predetermined fill volume of the dishwashing appliance. Thus, the vertical height of a fixed indicium 234 is set to match a specific volume of water or wash fluid within the dishwashing appliance. In turn, if the specific volume of water or wash fluid is present within the dishwashing appliance, the water line or height of the water surface will match or align with the fixed indicium 234. Optionally, the value of the predetermined fill volume may be printed or embedded above the corresponding fixed indicium. Multiple fixed indicia 234 may each correspond to a discrete or different predetermined fill volume. Notably, one or more easily distinguished visual indications of water volume may be provided.

In some embodiments, each fixed indicium 234 is circumferentially spaced apart from each other. In other words, each indicium 234 of the plurality of indicia 234 is circumferentially spaced apart from adjacent indicia 234 of the plurality of indicia 234. Thus, the plurality of indicia 234 will be horizontally offset from each other. Optionally, the fixed indicia 234 may be spaced apart according to a sequentially graduated pattern about the top cap 230. Thus, as traced along a circumferential direction, the height of adjacent indicia 234 may progressively increase. For instance, as shown, traced counterclockwise, adjacent indicia 234 may be increasingly taller and, thus, calibrated to increasing predetermined fill volumes. Optionally, the increase may be according to a set volumetric rate. As an example, each adjacent indicium 234 may be calibrated to increase along the circumferential direction by 0.2 gallon.

In optional embodiments, multiple indicia sets may be provided. For instance, multiple pluralities (e.g., a first plurality of indicia 234A and a second plurality of indicia 234B) may be provided at different locations on top cap 230. IN some such embodiments, the multiple indicia sets 234A, 234B provide duplicative indications of the same predetermined fill volumes (e.g., from different angles or orientation of the second filter 214). Each of the indicia sets 234A, 234B may be circumferentially spaced apart from each other. For instance, the region (e.g., angular window or range) of radial wall 236 including the first indicia set 234A may be circumferentially spaced apart from the region of the radial wall 236 including the second indicia set 234B. Notably, the second filter 214 may be inserted in multiple orientations (e.g., angles of rotation about the sump axis) while still providing a user with a visible line of sight.

Between the top cap 230 and drain pump 168, internal chamber 224 may define an unfiltered volume. A drain outlet may be defined below the openings 228 in fluid communication with internal chamber 224 and drain pump 168 (e.g., downstream of internal chamber 224 or upstream of drain pump 168).

During operation of some embodiments (e.g., during or as part of a wash cycle or rinse cycle), circulation pump 152 draws wash fluid in from sump 138 through filter assembly (e.g., through first filter 212 or second filter 214). At least a portion of wash fluid within sump 138 may generally pass into internal chamber 224 through second filter 214 (e.g., through filter wall 220 or openings 228) before flowing through drain assembly 166 and from dishwashing appliance 100. Thus, circulation pump 152 may be downstream of filter assembly 210.

In optional embodiments, circulation pump 152 urges or pumps wash fluid (e.g., from filter assembly 210) to a diverter 156. In some such embodiments, diverter 156 is positioned within sump 138 of dishwashing appliance 100). Diverter 156 may include a diverter disk (not shown) disposed within a diverter chamber 158 for selectively distributing the wash fluid to the spray arm assemblies 134, 140, 142, or other spray manifolds. For instance, the diverter disk may have a plurality of apertures that are configured to align with one or more outlet ports (not shown) at the top of diverter chamber 158. In this manner, the diverter disk may be selectively rotated to provide wash fluid to the desired spray device.

In exemplary embodiments, diverter 156 is configured for selectively distributing the flow of wash fluid from circulation pump 152 to various fluid supply conduits—only some of which are illustrated in FIG. 2 for clarity. In certain embodiments, diverter 156 includes four outlet ports (not shown) for supplying wash fluid to a first conduit for rotating lower spray arm assembly 134, a second conduit for supplying wash fluid to filter clean assembly 145, a third conduit for spraying an auxiliary rack such as the silverware rack, and a fourth conduit for supply mid-level or upper spray assemblies 140, 142 (e.g., primary supply conduit 154).

Drainage of soiled wash fluid within sump 138 may occur, for instance, through drain assembly 166 (e.g., during or as part of a drain cycle). In particular, wash fluid may exit sump 138 through a drain and may flow through a drain conduit 167. In some embodiments, a drain pump 168 downstream of sump 138 facilitates drainage of the soiled wash fluid by urging or pumping the wash fluid to a drain line external to dishwasher 100. Drain pump 168 may be downstream of first filter 212 or second filter 214. Additionally or alternatively, an unfiltered flow path may be defined through sump 138 to drain conduit 167 such that an unfiltered fluid flow may pass through sump 138 to drain conduit 167 without first passing through either first filter 212 or second filter 214.

Although a separate recirculation pump 152 and drain pump 168 are described herein, it is understood that other suitable pump configurations (e.g., using only a single pump for both recirculation and draining) may be provided.

In certain embodiments, dishwasher 100 includes a controller 160 configured to regulate operation of dishwasher 100 (e.g., initiate one or more washing operations). Controller 160 may include one or more memory devices and one or more microprocessors, such as general or special purpose microprocessors operable to execute programming instructions or micro-control code associated with a washing operation that may include a wash cycle, rinse cycle, or drain cycle. The memory may represent random access memory such as DRAM, or read only memory such as ROM or FLASH. In some embodiments, the processor executes programming instructions stored in memory. The memory may be a separate component from the processor or may be included onboard within the processor. Alternatively, controller 160 may be constructed without using a microprocessor (e.g., using a combination of discrete analog or digital logic circuitry—such as switches, amplifiers, integrators, comparators, flip-flops, AND gates, and the like—to perform control functionality instead of relying upon software).

Controller 160 may be positioned in a variety of locations throughout dishwasher 100. In optional embodiments, controller 160 is located within a control panel area 162 of door 116 (e.g., as shown in FIGS. 1 and 2). Input/output (“I/O”) signals may be routed between the control system and various operational components of dishwasher 100 along wiring harnesses that may be routed through the bottom of door 116. Typically, the controller 160 includes a user interface panel/controls 164 through which a user may select various operational features and modes and monitor progress of dishwasher 100. In some embodiments, user interface 164 includes a general purpose I/O (“GPIO”) device or functional block. In additional or alternative embodiments, user interface 164 includes input components, such as one or more of a variety of electrical, mechanical or electro-mechanical input devices including rotary dials, push buttons, and touch pads. In further additional or alternative embodiments, user interface 164 includes a display component, such as a digital or analog display device designed to provide operational feedback to a user. When assembled, user interface 164 may be in operative communication with the controller 160 via one or more signal lines or shared communication busses.

It should be appreciated that the invention is not limited to any particular style, model, or configuration of dishwasher 100. The exemplary embodiment depicted in FIGS. 1 and 2 is for illustrative purposes only. For instance, different locations may be provided for user interface 164, different configurations may be provided for rack assemblies 122, 124, 126, different spray arm assemblies 134, 140, 142 and spray manifold configurations may be used, and other differences may be applied while remaining within the scope of the present disclosure.

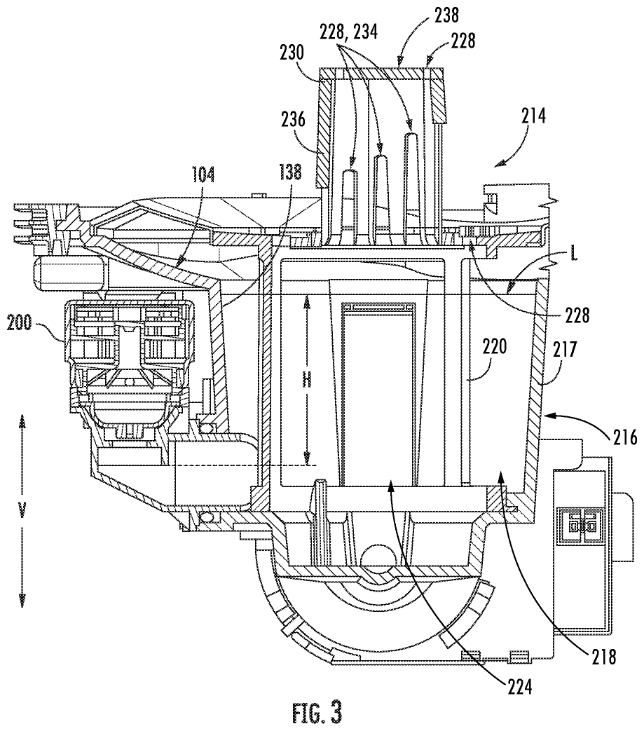

Turning especially to FIG. 3, a close up, cross sectional view of sump 138 and a pressure sensor 200 is provided. In some instances, portions of dishwasher 100 may become obstructed or clogged (e.g., at filter assembly 210). Accordingly, and in accordance with exemplary aspects of the present disclosure, dishwasher 100 utilizes outputs from pressure sensor 200 to monitor or prevent obstructions or clogs.

In some embodiments, pressure sensor 200 mounted to sump 138 (e.g., upstream from second filter 214). Pressure sensor 200 is operatively configured to detect a liquid level L within sump 138 and communicate the liquid level L to controller 160 (FIG. 2) via one or more signals. Thus, pressure sensor 200 and controller 160 are generally provided in operative communication. In some embodiments, pressure sensor is further mounted within the cabinet at a location below the top cap (e.g., to detect the pressure visually indicated at top cap).

During use, pressure sensor 200 may transmit signals to controller 160 for instance, as a frequency, as an analog signal, or in another suitable manner or form that can be received by controller 160 to detect a pressure value (e.g., as a value of relative pressure or hydrostatic pressure, such as value in units of mmH₂O). In certain embodiments, pressure sensor 200 is configured to sense the height H of the wash fluid above pressure sensor 200 along the vertical direction V (e.g., by detecting the pressure on pressure sensor 200). For instance, pressure sensor 200 may include a pressure plate that is generally acted on by the pressure of the wash fluid within sump 138. As the liquid level L rises, the pressure plate is pushed upward along the vertical direction V and, thus, compresses air trapped within the housing and a diaphragm of pressure sensor 200. Compression may cause the diaphragm to flex or alter its position. As a result of the pressure and consequent movement of the diaphragm, a permanent magnet attached to the diaphragm may change its position in relation to a Hall-effect transducer. The transducer delivers one or more electrical signals proportional to the magnetic field of the magnet. Optionally, the signals from pressure sensor 200 may be linearized, digitized, or amplified before being sent to controller 160 for processing. Additionally or alternatively, the pressure sensor 200 may include a printed circuit board (PCB) board to electrically connect the various electrical components of pressure sensor 200. Moreover, pressure sensor 200 can be any suitable type of sensor capable of sensing the liquid level L within dishwasher 100.

Notably, as an upstream sensor (e.g., upstream of circulation pump 152, drain pump 168, or second filter 214), signals from pressure sensor 200 may be used or configured for additional detections, such as detection of overfill or flood event (e.g., as would be caused by an out-of-level condition, an inlet water valve failure, or a drain pump failure) that would otherwise go undetected by a pressure sensor downstream (i.e., on the high-pressure side) of circulation pump 152 or drain pump 168.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dishwashing appliance, comprising:
a cabinet;
a tub positioned within the cabinet and defining a wash chamber for receipt of articles for washing;
a sump positioned at a bottom portion of the tub along a vertical direction, the sump comprising an internal wall defining a collection chamber; and
a filter assembly at least partially received within the collection chamber, the filter assembly comprising a top cap extending above the collection chamber, the top cap comprising a fixed indicium calibrated to a predetermined fill volume of the dishwashing appliance.

2. The dishwashing appliance of claim 1, wherein the fixed indicium defines a radial slot extending through the top cap to permit a flow of water to the collection chamber.

3. The dishwashing appliance of claim 1, wherein the filter assembly further comprises a plurality of indicia calibrated to discrete predetermined fill volumes, and wherein the fixed indicium is one indicium of the plurality of indicia.

4. The dishwashing appliance of claim 3, wherein the plurality of indicia is a first plurality of indicia, wherein the top cap further comprises a second plurality of indicia calibrated to the discrete predetermined fill volumes, and wherein the second plurality of indicia is circumferentially spaced apart from the first plurality of indicia.

5. The dishwashing appliance of claim 3, wherein each indicium of the plurality of indicia is circumferentially spaced apart from one or more adjacent indicia of the plurality of indicia.

6. The dishwashing appliance of claim 5, wherein the plurality of indicia are spaced apart according to a sequentially graduated pattern about the top cap.

7. The dishwashing appliance of claim 1, wherein the filter assembly comprises a cylindrical wall formed from one or more fine filter media extending below the top cap.

8. The dishwashing appliance of claim 7, further comprising a coarse filter disposed about the filter assembly above the cylindrical wall and below the top cap.

9. The dishwashing appliance of claim 1, wherein the top cap further defines a plurality of vertical holes extending through an upper surface of the top cap above the fixed indicium.

10. The dishwashing appliance of claim 1, further comprising a pressure sensor mounted within the cabinet upstream of the filter assembly at a location below the top cap.

11. A dishwashing appliance, comprising:
a cabinet;
a tub positioned within the cabinet and defining a wash chamber for receipt of articles for washing;
a sump positioned at a bottom portion of the tub along a vertical direction, the sump comprising an internal wall defining a collection chamber;
a filter assembly at least partially received within the collection chamber, the filter assembly comprising a top cap extending above the collection chamber, the top cap comprising a plurality of indicia calibrated to discrete predetermined fill volumes; and
a coarse filter disposed about the filter assembly below the top cap.

12. The dishwashing appliance of claim 11, wherein each fixed indicium of the plurality of indicia defines a radial slot extending through the top cap to permit a flow of water to the collection chamber.

13. The dishwashing appliance of claim 11, wherein the plurality of indicia is a first plurality of indicia, wherein the top cap further comprises a second plurality of indicia calibrated to the discrete predetermined fill volumes, and wherein the second plurality of indicia is circumferentially spaced apart from the first plurality of indicia.

14. The dishwashing appliance of claim 13, wherein each fixed indicium of the plurality of indicia is circumferentially spaced apart from one or more adjacent indicia of the plurality of indicia.

15. The dishwashing appliance of claim 14, wherein the plurality of indicia are spaced apart according to a sequentially graduated pattern about the top cap.

16. The dishwashing appliance of claim 11, wherein the filter assembly comprises a cylindrical wall formed from one or more fine filter media extending below the top cap.

17. The dishwashing appliance of claim 16, wherein the coarse filter is disposed above the cylindrical wall and below the top cap.

18. The dishwashing appliance of claim 11, wherein the top cap further defines a plurality of vertical holes extending through an upper surface of the top cap above the plurality of indicia.

19. The dishwashing appliance of claim 11, further comprising a pressure sensor mounted within the cabinet upstream of the filter assembly at a location below the top cap.
